(19) United States
(12) Patent Application Publication
(10) Pub. No.: US 2026/0022749 A1
(43) Pub. Date: Jan. 22, 2026

(54) ELECTROMECHANICALLY ACTUATABLE BRAKE ACTUATOR

(71) Applicant: ZF Active Safety GmbH, Koblenz (DE)

(72) Inventors: Lukas Madzgalla, Lahnstein (DE); Florian Roessinger, Neuwied (DE)

(21) Appl. No.: 19/272,466

(22) Filed: Jul. 17, 2025

(30) Foreign Application Priority Data
Jul. 18, 2024 (DE) 102024120268.8

(51) Int. Cl. F16D 65/18; F16D 121/20; F16D 125/40

(52) U.S. Cl. CPC F16D 65/18; F16D 2121/20; F16D 2125/40

(57) ABSTRACT

The invention relates to an electromechanically actuatable brake actuator 1 for a motor vehicle disc brake 100, comprising a brake calliper housing 5 with a cylindrical recess 6, and a spindle drive 10 comprising a drive spindle 20 and comprising a linearly movably guided brake piston arrangement 40, wherein the drive spindle 20 has a first spindle end 22 with a drive geometry 23 for transmitting a torque to the drive spindle 20, and a second spindle end 25, wherein the brake piston arrangement 40 has a spindle nut 42 which is operatively connected in drive terms to the drive spindle 20, a sliding guide 44 by means of which the brake piston arrangement 40 is guided in the cylindrical recess 6, and a brake piston 48 for actuating at least one brake pad arrangement, wherein the brake piston arrangement 40 has an open side 51, a circumferential wall 54 and a closed base 55 opposite the open side 51, so that the brake piston arrangement 40 has an internal space 59, wherein the second spindle end 25 projects into the internal space 59 through the open side 51, characterized in that an axial bearing 70 is arranged between the second spindle end 25 and the closed base 55.

### TECHNICAL FIELD

The invention relates to an electromechanically actuatable brake actuator for a motor vehicle disc brake, having a spindle drive, which comprises a drive spindle and a linearly movably guided brake piston arrangement. The invention also relates to a motor vehicle disc brake having such a brake actuator. Furthermore, the invention relates to a method for determining a position of, and positioning, a corresponding brake piston arrangement. The invention also relates to a spindle drive.

### BACKGROUND

In electromagnetically actuatable brake actuators for motor vehicle disc brakes, a brake piston arrangement is usually mounted in a cylindrical recess in the brake calliper so as to be axially displaceable and secured against rotation. By means of a drive spindle, which can be set in rotation via a drive geometry on a first spindle end, the brake piston arrangement can be moved in the axial direction. By means of the brake piston arrangement, a brake pad or a plurality of brake pads can be pressed in this way against a brake disc or released from the latter. The drive spindle usually has an external thread and the brake piston arrangement has an internal thread, so that the two components interact as a spindle drive.

The brake piston arrangement can be moved into the cylindrical recess in the brake calliper, i.e. moved into a “retracted” position. A retracted position is present, for example, when the associated brake pads or an associated brake pad are or is separated from the brake disc. The brake piston arrangement can also be moved a little further out of the cylindrical recess in the brake calliper, i.e. moved into an “extended” position. An extended position is present, for example, when the associated brake pads or an associated brake pad are or is applied to the brake disc. Depending on the pad thickness of the brake pads or the state of wear of the brake pads, the brake piston arrangement can assume various positions as it is extended.

Usually, a brake piston arrangement has an open side, a circumferential wall and a closed base opposite the open side. Because of the circumferential wall thickness, the brake piston arrangement has a circumferential surface which delimits it in the axial direction and with which the brake piston arrangement projects into the cylindrical recess. In such solutions from the prior art, the problem arises that, as the brake piston arrangement is moved in, the cylindrical surface is moved until it is blocked against a corresponding housing base. Depending on the speed at which they are moved together, this can lead to damage to the axial securing means of the drive spindle. While the brake piston arrangement comes to a standstill immediately when it makes contact with the housing, the drive spindle is still able to move a little further in the axial direction. If the drive spindle is, for example, secured with respect to the housing by means of a securing ring in order to secure its axial position, an excessive force can act on, and possibly destroy, the securing ring as a result of the brake piston arrangement and housing being moved together. Damage to other components is also possible.

A further problem in solutions from the prior art lies in the fact that a reference position of the brake piston arrangement can be determined only inadequately or is too elaborate.

### SUMMARY

It is thus an object of the present invention to provide an electromechanically actuatable brake actuator, the brake piston arrangement of which can be moved into any retracted position without any disruption, without any damage and without jamming, and to provide a motor vehicle disc brake having such a brake actuator. The object of the invention further lies in specifying a method which permits accurate and inexpensive determination of a reference position of the brake piston arrangement. Furthermore, the object of the present invention is to provide a spindle drive in which axial jamming between spindle and spindle nut is avoided.

According to the invention, the object is achieved by an electromagnetically actuatable brake actuator having the features of Claim 1, by a motor vehicle disc brake having the features of Claim 9, by a method having the method steps of Claim 10 and by a spindle drive having the features of Claim 11. Advantageous embodiments of the invention are specified in the subordinate claims 2 to 8.

The electromechanically actuatable brake actuator according to the invention for a motor vehicle disc brake comprises a brake calliper housing with a cylindrical recess and a spindle drive comprising a drive spindle and comprising a linearly movably guided brake piston arrangement. The drive spindle has a first spindle end with a drive geometry for transmitting a torque to the drive spindle, and a second spindle end. The brake piston arrangement has a spindle nut which is operatively connected to the drive spindle in drive terms, a sliding guide, by means of which the brake piston arrangement is guided in the cylindrical recess, and a brake piston for actuating at least one brake pad arrangement. The brake piston arrangement has an open side, a circumferential wall and a closed base opposite the open side, so that an internal space is accordingly formed in the brake piston arrangement. The second spindle end projects into the internal space through the open side. According to the invention, an axial bearing is arranged between the second spindle end and the closed base.

The drive spindle can be set in rotation by means of the drive geometry, which is preferably a shaft pin having a form or force fit. The drive is preferably provided by an electric motor or an electric motor and an interposed gear mechanism. Because of the axial bearing between the second spindle end and the closed base, moving the drive spindle and the brake piston arrangement together without jamming is possible. When the brake piston arrangement is moved to the maximum extent into a retracted position, the drive spindle and brake piston arrangement are moved together so as to block. This means that in this case there is no longer any play in the series circuit or arrangement of the spindle end, axial bearing and closed base of the brake piston arrangement. Nevertheless, because of the properties of the axial bearing, the components do not jam. An axial bearing transmits forces in the axial direction and, when moved together, the axial bearing no longer allows any axial movement. Nevertheless, the axial bearing offers a degree of rotational freedom about the longitudinal or rotational axis of the drive spindle, so that the brake piston arrangement can readily be moved out of the retracted position again.

Preferably, in a first retracted position of the brake piston arrangement, the axial bearing is in contact both with the second spindle end and with the closed base. Preferably, in the first retracted position, an axial force is transmitted between the second spindle end and the closed base. As already explained above, the closed base and the second spindle end are moved together in this situation such that there is no longer any play axially between these components. However, the axial bearing which transmits the axial forces is arranged between the closed base and the second spindle end; releasing the components that have been moved together is easily made possible. The fact that the second spindle end is brought into contact with the closed base results in a simultaneous stop of movement both of the brake piston arrangement in this maximally retracted position and of the drive spindle. The drive spindle cannot rotate further and move axially as a result, as in the prior art, after reaching this position of the brake piston arrangement. Thus, damage to components, in particular the drive spindle bearing and the axial securing means of the drive spindle, is avoided.

Preferably, the second spindle end has a first contact surface oriented transversely with respect to the longitudinal axis of the drive spindle. In the present case, “transversely” means that the contact surface can also be conical. However, the first contact surface is preferably oriented orthogonally to the longitudinal axis of the drive spindle. The first contact surface is preferably an end face of the second spindle end. Preferably, the closed base has in the internal space a second contact surface oriented transversely, preferably oriented orthogonally, to the longitudinal axis of the drive spindle. The second contact surface is preferably the base surface of the closed base. In the first retracted position, the first contact surface is preferably in contact with a first bearing side of the axial bearing, and the second contact surface is in contact with a second bearing side of the axial bearing, opposite the first bearing side.

In a preferred embodiment of the brake actuator, the axial bearing is fastened to the second spindle end. In this way, the axial bearing can be mounted securely and easily. Preferably, the axial bearing is inserted into a depression in the end face of the second spindle end.

Particularly preferably, the axial bearing is designed as a rolling contact bearing. In a rolling contact bearing, because of the rolling friction between bearing surfaces and rolling elements, moving the components apart is easily possible even under high axial forces, which can occur when drive spindle and brake piston arrangement are moved together. Alternatively, a plain bearing, preferably a sliding disc, can also be used as an axial bearing.

The spindle drive is preferably configured as a ball-screw drive (also called a recirculating ball spindle drive). Ball-screw drives have a high efficiency and are not self-locking. This is important overall for efficient dimensioning of the brake actuator and a corresponding disc brake. However, it also contributes to the fact that, after being moved into a state in which it is blocked, i.e. in the maximum retracted position of the brake piston arrangement, the brake piston arrangement can easily be moved out of the cylindrical recess again. The drive spindle preferably has an external thread for guiding balls, and the brake piston arrangement or the spindle nut of the brake piston arrangement has an internal thread for guiding the balls, wherein the drive spindle, balls and spindle nut together form the ball-screw drive. The balls are preferably guided back in the drive spindle.

In a preferred refinement of the brake actuator, the spindle nut, the sliding guide and the brake piston are formed jointly as a one-piece component. This means that the brake piston arrangement combines the three functional units in a one-piece component. In this case, the brake piston arrangement is a brake piston which forms the sliding guide with its circumferential wall and, on the inside of the circumferential wall, has an internal thread which is operatively connected in drive terms to the external thread of the drive spindle.

Preferably, the brake actuator is configured in such a way that the brake piston arrangement can be moved into a definable second retracted position by means of an electronic controller, wherein, in the second retracted position of the brake piston arrangement, the axial bearing is not in contact with the closed base or transmits no axial force between the second spindle end and the closed base. Using the brake actuator according to the invention, starting from the first retracted position of the brake piston arrangement, in which the closed base is in play-free contact with the second spindle end via the axial bearing, it is thus possible to move the brake piston arrangement into a definable second retracted position with the aid of an electronic controller. This could be, for example, the position in which the desired clearance between brake pad and brake disc is established. Thus, the first retracted position can be used as a reference position, starting from which an electric controller can move the brake piston arrangement into definable further axial positions of the brake piston arrangement by actuating an associated electric motor.

The motor vehicle disc brake according to the invention has an electromechanically actuatable brake actuator according to the preceding or following description. The features, technical effects and advantages described in relation to the brake actuator according to the invention also apply analogously to the motor vehicle disc brake.

The method according to the invention for determining the position of the brake piston arrangement of the above-described brake actuator has the following steps:
Moving the brake piston arrangement into the first retracted position.
Storing the value of the position of the brake piston arrangement in the first retracted position by means of an electronic controller.
Calculating a value of a variable for activating the drive spindle by means of the electronic controller in order to be able to move the brake piston arrangement into a determinable position differing from the first retracted position. Preferably, the position differing from the first retracted position corresponds to the second retracted position which has been explained in the preceding description. This method, in conjunction with the brake piston arrangement according to the invention, represents an accurate and inexpensive solution for determining a reference position of the brake piston arrangement.

The spindle drive according to the invention comprises a spindle, preferably a drive spindle, having a first contact surface, preferably an end face, oriented transversely, preferably orthogonally, with respect to the longitudinal axis of the spindle. The spindle drive further comprises a spindle nut which is operatively connected in drive terms to the spindle, having a second contact surface oriented transversely, preferably orthogonally, with respect to the longitudinal axis of the spindle. An axial bearing, preferably a rolling contact bearing or a sliding disc, is arranged between the first contact surface and the second contact surface.

In a preferred refinement of the spindle drive, in a first axial position of the spindle nut with respect to the spindle, the axial bearing is in contact both with the first contact surface and with the second contact surface. Alternatively or additionally, in the first axial position of the spindle nut with respect to the spindle, the axial bearing transmits an axial force between the first contact surface and the second contact surface. In this refinement of the spindle drive, in at least one further axial position of the spindle nut with respect to the spindle, the axial bearing transmits no axial force between the first contact surface and the second contact surface. Alternatively or additionally, the axial bearing is in contact only with one of the first and the second or with neither of the first and the second contact surfaces.

The technical effects and advantages of the brake actuator according to the invention, in particular its spindle drive, also apply analogously to the aforementioned embodiments of the spindle drive according to the invention.

### BRIEF DESCRIPTION OF THE DRAWINGS

Further features, advantages and possible applications of the present invention are gathered from the following description of an exemplary embodiment and the schematic FIG. 1. In FIG. 1, the same reference signs can also designate the same or similar objects.

FIG. 1 shows an exemplary embodiment of the brake actuator according to the invention, a detail of a motor vehicle disc brake according to the invention and also an exemplary embodiment of the spindle drive according to the invention.

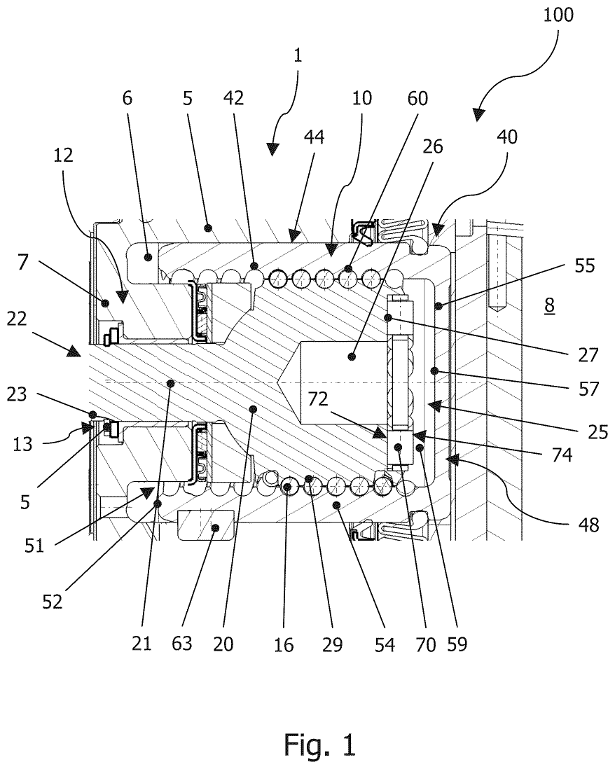

### DESCRIPTION

A cylindrical recess 6, which is open towards the brake disc well 8 and is delimited in its deepest region in the axial direction by a housing base 7, is introduced into the brake calliper housing 5 of the brake actuator 1. A brake piston arrangement 40 is arranged in the cylindrical recess 6 so as to be axially displaceable and secured against rotation.

The brake piston arrangement 40 in the exemplary embodiment of the invention combines a brake piston 48, a spindle nut 42 and a sliding guide 44 in one piece in a component. Although the aforementioned components are therefore designed as one component in the present case, the individual components (at least these are different sections or regions), i.e. the brake piston 48, the spindle nut 42 and the sliding guide 44, are provided with reference numbers. The brake piston arrangement 40 is pot-shaped and has a closed base 55, which projects out of the cylindrical recess 6, a circumferential wall 54 and an open side 51. As a result, the brake piston arrangement 40 has an internal space 59, in which a drive spindle 20 is placed. The circumferential wall 54 has the sliding guide 44 on its outer side, with which the brake piston arrangement 40 is guided in a sliding manner in the cylindrical recess 6 of the brake calliper housing 5. By means of an anti-rotation securing means 63, which is guided in a groove, the brake piston arrangement 40 is secured against rotation with respect to the brake calliper housing 5. The brake piston arrangement 40 has an internal thread 61 on the inside of the circumferential wall 54.

The drive spindle 20 has a first spindle end 22, which projects through the housing base 7 of the brake calliper housing 5 and has a drive geometry 23. Via this drive geometry 23, the drive spindle 20 can be driven in rotation by an electric motor. The drive geometry can be formed, for example, as a groove or a splined shaft profile. In the region of the first spindle end 22, the drive spindle 20 is mounted and supported with respect to the housing base 7 by means of a spindle bearing 12 by means of bearing elements and secured axially by an axial securing means 13. The axial securing means comprises a securing ring 14.

The drive spindle 20 extends along its longitudinal axis 21, which is also simultaneously its axis of rotation, into the internal space 59 and is delimited axially there by a second spindle end 25. The drive spindle 20 has an external thread 29 in the spindle region which projects into the internal space 59. The drive spindle 20 and the brake piston arrangement 40 together form a spindle drive 10. The internal thread 61 and the external thread 29 are operatively connected in drive terms. Since the present spindle drive 10 is configured as a ball-screw drive, balls 16 are arranged and movably guided in the thread turns of the drive spindle 20 and the brake piston arrangement 40 or the spindle nut 42, so that the balls 16 are also a constituent part of the spindle drive 10 in this exemplary embodiment. The balls are returned within the drive spindle 20. The drive spindle 20 has a larger spindle diameter in the region where the external thread 29 is arranged than in the region of the first spindle end. Furthermore, the drive spindle 20 has a blind hole in the region of the second spindle end 25, which is introduced into the drive spindle 20 from the first contact surface 27.

Because of the configuration of the spindle drive 10, the brake piston arrangement 40, which is axially movable but arranged fixed against rotation, can be moved axially by the rotation of the drive spindle 20, which is rotatably mounted but axially fixed. As a result of actuating the brake actuator 1, the brake piston arrangement 40 can be moved into the cylindrical recess 6 (retracted position) or moved out of the cylindrical recess 6 in order to press associated brake pads against an associated brake disc or to release them from the latter.

On the second spindle end 25, the drive spindle 20 has an axial bearing 70, which is designed as a rolling contact bearing. The rolling elements can be, for example, rolling contact needles or cylindrical rollers, the axes of rotation of which extend orthogonally to the longitudinal axis 21 of the drive spindle 20. The second spindle end 25 has a first contact surface 27, on which the rolling elements are supported or on which they roll. This means that the axial bearing 70 has a first bearing side 72 there. This is in contact with the first contact surface 27. The first contact surface 27 is countersunk somewhat into the second spindle end 25, so that the axial bearing 70 has a corresponding bearing seat.

The closed base 55 has a second contact surface 57 on its inner side, i.e. in the internal space 59. This extends parallel to the first contact surface 27. If the brake actuator 1 is actuated in such a way that the brake piston arrangement 40 is moved into the maximum possible retracted position, the second contact surface 57 comes into contact with the second bearing side 74 opposite the first bearing side 72 of the axial bearing 70. This prevents the brake piston arrangement 40 from being moved against the brake calliper housing 5 at another point. As soon as the brake piston arrangement 40 comes into play-free contact with the drive spindle 20 in this way, i.e. via the axial bearing 70, these two spindle drive components simultaneously come to a standstill and no undesired axial movement of the drive spindle 20 follows. As a result, damage to components, in particular the axial securing means 13, is avoided. If the brake piston arrangement 40 and the drive spindle 20 are moved so as to block each other in this way, this situation also represents a reliable and reproducible reference position of the brake piston arrangement 40 and can be used for the positioning of the brake piston arrangement 40 in other determinable positions by means of an electronic controller.

1. Electromechanically actuatable brake actuator (1) for a motor vehicle disc brake (100), comprising
a brake calliper housing (5) with a cylindrical recess (6), and
a spindle drive (10) comprising a drive spindle (20) and comprising a linearly movably guided brake piston arrangement (40),
wherein the drive spindle (20) has a first spindle end (22) with a drive geometry (23) for transmitting a torque to the drive spindle (20), and a second spindle end (25),
wherein the brake piston arrangement (40) has a spindle nut (42) which is operatively connected in drive terms to the drive spindle (20), a sliding guide (44) by means of which the brake piston arrangement (40) is guided in the cylindrical recess (6), and a brake piston (48) for actuating at least one brake pad arrangement,
wherein the brake piston arrangement (40) has an open side (51), a circumferential wall (54) and a closed base (55) opposite the open side (51), so that the brake piston arrangement (40) has an internal space (59),
wherein the second spindle end (25) projects into the internal space (59) through the open side (51),
wherein an axial bearing (70) is arranged between the second spindle end (25) and the closed base (55).

2. Brake actuator (1) according to claim 1,
wherein, in a first retracted position of the brake piston arrangement (40), the axial bearing (70) is in contact both with the second spindle end (25) and with the closed base (55) and/or transmits an axial force between the second spindle end (25) and the closed base (55).

3. Brake actuator (1) according to claim 1,
wherein the second spindle end (25) has a first contact surface (27), in particular an end face, oriented transversely, in particular orthogonally, with respect to the longitudinal axis (21) of the drive spindle (20), wherein the closed base (55) has in the internal space (59) a second contact surface (57), in particular a base surface, oriented transversely, in particular orthogonally, with respect to the longitudinal axis (21) of the drive spindle (20), wherein, in the first retracted position, the first contact surface (27) is in contact with a first bearing side (72) of the axial bearing (70), and the second contact surface (57) is in contact with a second bearing side (74) of the axial bearing (70) opposite the first bearing side (72).

4. Brake actuator (1) according to claim 1,
wherein the axial bearing (70) is fastened to the second spindle end (25).

5. Brake actuator (1) according to claim 1,
wherein the axial bearing (70) is a rolling contact bearing or a plain bearing, in particular a sliding disc.

6. Brake actuator (1) according to claim 1,
wherein the spindle drive (10) is a ball-screw drive.

7. Brake actuator (1) according to claim 1,
wherein the spindle nut (42), the sliding guide (44) and the brake piston (48) are formed as a one-piece component.

8. Brake actuator (1) according to claim 2,
wherein the brake actuator (1) is configured in such a way that the brake piston arrangement (40) can be moved into a definable second retracted position by means of an electronic controller, wherein, in the second retracted position of the brake piston arrangement (40), the axial bearing (70) is not in contact with the closed base (55) and/or transmits no axial force between the second spindle end (25) and the closed base (55).

9. Motor vehicle disc brake (100) having an electromechanically actuatable brake actuator (1) according to claim 1.

10. Method for determining the position of the brake piston arrangement (40) of a brake actuator (1) according to claim 8, having the steps
moving the brake piston arrangement (40) into the first retracted position,
storing the value of the position of the brake piston arrangement (40) in the first retracted position by means of an electronic controller,
calculating a value of a variable for activating the drive spindle (20) by means of the electronic controller in order to be able to move the brake piston arrangement (40) into a determinable position differing from the first retracted position, in particular into the second retracted position.

11. Spindle drive (10), comprising
a spindle (20), in particular a drive spindle, having a first contact surface (27), in particular an end face, oriented transversely, in particular orthogonally, with respect to the longitudinal axis (21) of the spindle (20), and
a spindle nut (42), which is operatively connected in drive terms to the spindle (20), having a second contact surface (57) oriented transversely, in particular orthogonally, with respect to the longitudinal axis (21) of the spindle (20),
wherein an axial bearing (70), in particular a rolling contact bearing or a sliding disc, is arranged between the first contact surface (27) and the second contact surface (57),
wherein, in a first axial position of the spindle nut (42) with respect to the spindle (20), the axial bearing (70) is in contact both with the first contact surface (27) and with the second contact surface (57) and/or transmits an axial force between the first contact surface (27) and the second contact surface (57),
wherein, in at least one further axial position of the spindle nut (42) with respect to the spindle (20), the axial bearing (70) transmits no axial force between the first contact surface (27) and the second contact surface (57) and/or wherein the axial bearing (70) is in contact only with one of the first and the second or with neither of the first and the second contact surfaces (27, 57).
